(19) United States
(12) Patent Application Publication
(10) Pub. No.: US 2015/0032411 A1
(43) Pub. Date: Jan. 29, 2015

(54) Envelope Calculation By Means of Phase Rotation

(71) Applicant: VEGA Grieshaber KG, Wolfach (DE)

(72) Inventors: Christian Hoferer, Offenburg (DE); Roland Welle, Oberwolfach (DE); Werner Reich, Offenburg (DE)

(21) Appl. No.: 14/373,594

(22) PCT Filed: Jan. 25, 2013
(86) PCT No.: PCT/EP2013/051494

§ 371 Date: Jul. 21, 2014

Related U.S. Application Data
(60) Provisional application No. 61/590,526, filed on Jan. 25, 2012.

(30) Foreign Application Priority Data
Jan. 25, 2012 (EP) 12 152 457.3

(51) Int. Cl. G01C 1/00; G01B 21/22

(52) U.S. Cl. CPC G01C 1/00; G01B 21/22
USPC 702/154

(57) ABSTRACT

According to an embodiment of the invention, the received signal of a level sensor is sampled at discrete times, and the sampled values are digitised. New values are obtained from the digitised sample values by rotating the phase through a predetermined angle, which new values are then used together with the digital sample values to calculate the envelope curve.

### FIELD OF THE INVENTION

The invention relates to level measurement and in particular relates to a method for calculating an envelope-curve value in the level measurement by a level sensor, and relates to a pulse transit-time sensor for calculating an envelope-curve value in the level measurement.

### BACKGROUND

In order to determine continuously the level in containers that hold, for example, liquids or bulk solids, sensors are often used that employ the pulse transit-time technique to measure the transit time of electromagnetic or acoustic waves from the sensor to the surface of the contained product and back. From the distance between sensor and surface of the contained product, which is determined from the pulse transit-time using the wave velocity, then if the installation position of the sensor relative to the container base is known, it is possible to calculate directly the level being sought.

DE 10 2006 006 572 A1 describes an iterative calculation to form an envelope curve of a time-expanded received signal (known as the intermediate frequency signal or IF signal) of a pulse transit-time level sensor. The IF signal is sampled at discrete times, and the sampled values are converted into digital sample values. Then each envelope-curve value is calculated from exactly two digital sample values at a time. The envelope curve is thus the envelope of the IF signal or an approximation to this envelope. The envelope curve is a curve that is plotted by the individual, calculated envelope-curve values or is an approximate fit to the individual envelope-curve values. The terms envelope curve and envelope-curve value are known to a person skilled in the art from DE 10 2006 006 572 A1.

### SUMMARY OF THE INVENTION

An object of the invention is to calculate the envelope (envelope curve) of a signal and in particular of a received signal of a pulse transit-time level sensor.

This object is achieved by the features of the independent claims. The dependent claims and the following description contain developments of the invention.

According to a first aspect of the invention, a method is defined for calculating an envelope-curve value in a level measurement by a level sensor. In the method, the received signal of the level sensor is sampled at discrete times at least in one region, and the time-discrete (analogue) sample values of the sampled received signal are then converted into digital sample values. Then a new value for a first digital sample value of the digital sample values is calculated by rotating the phase of the sample value of the sampled region of the received signal through a predetermined angle. This calculation of the new value is performed, for example, using a plurality of the digital sample values. Then an envelope-curve value is calculated from the first digital sample value and from the new value calculated by the phase rotation.

The phase of a sample value shall be understood to mean here the phase angle of the received signal at the time the signal was sampled.

Sensors that are suitable for performing the method described above and below are, for example, pulse transit-time level sensors, radar level sensors or ultrasound level sensors for measuring a level.

According to a further aspect of the invention, the received signal is converted into a time-expanded intermediate frequency signal before sampling. So when “received signal” is mentioned below, it may refer to a time-expanded signal or a non-time-expanded signal. If an “intermediate frequency signal” or “IF signal” is referred to below, this can also denote a “received signal”

According to a further aspect of the invention, each envelope-curve value is generated as the root of the sum of the squares of one sampled value and one calculated value. The formula given in the following description can be used for this, for example.

According to a further aspect of the invention, the conversion of the sample values of the sampled received signal is performed by subsampling. In subsampling, the analogue signal is converted into digital values without complying with the Nyquist-Shannon sampling theorem. This means that the sampling frequency is less than twice the maximum frequency that occurs in the signal to be sampled. DE 10 2006 006 572 A1, in particular in paragraphs 87 and 88, explains what can be understood by such subsampling.

According to a further aspect of the invention, the predetermined angle has a value not equal to 90 degrees.

According to a further aspect of the invention, the predetermined angle has a value equal to 90 degrees, where the phase rotation is performed by a Hilbert filter.

According to a further aspect of the invention, the phase rotation is performed by a digital filter in the time domain.

According to a further aspect of the invention, the filter has an FIR filter structure or an IIR filter structure.

According to a further aspect of the invention, the phase rotation is performed by a digital filter in the frequency domain.

According to a further aspect of the invention, the digital filter performs a Fourier transform.

According to a further aspect of the invention, coherent ensemble averaging is performed before calculating the envelope-curve values. In coherent ensemble averaging, the envelope-curve values of different envelope curves are not averaged but the digitised values of different IF signals are, which results in an improved signal-to-noise ratio.

According to a further aspect of the invention, a multiplicity of envelope-curve values are calculated, from which the overall characteristic of the envelope curve is then determined.

According to a further aspect of the invention, a level sensor for calculating an envelope-curve value of an envelope curve and for determining a level of a medium is defined, which sensor is a pulse transit-time level sensor, for instance. The level sensor comprises a sampling device for sampling at least one region of a received signal at discrete times and for converting the sampled values into digital sample values. In addition, a digital signal processing device is provided, which calculates a new value for a first digital sample value of the digital sample values by rotating the phase of the IF signal that corresponds to this first digital sample value through a predetermined angle. Then an envelope-curve value is calculated from the first digital sample value and from the new value calculated by the phase rotation.

According to a further aspect of the invention, the level sensor is designed in particular to perform the method described above and below.

According to a further aspect of the invention, a signal processing unit comprising a sampling device and a processor for calculating an envelope-curve value of an analogue signal is defined, which unit is designed to perform the method steps described above and below.

According to a further aspect of the invention, a program element is defined, which, when executed on a processor, and in particular on a processor of a level sensor, instructs a signal processing device to perform the steps described above and below for calculating the new values and the envelope-curve values.

In this case, the program element can be part of a piece of software, for example, that is stored on a processor of a level sensor. The processor here can likewise be the subject-matter of the invention. In addition, this embodiment of the invention comprises a program element which right from the start uses the invention, such as also a program element that by an update causes an existing program to use the invention.

According to a further aspect of the invention, a computer-readable medium is defined on which an above-described program element is stored.

It can be considered a core aspect of the invention that the received signal, or a region thereof, which extends over a metre, for example, if applicable after a time expansion (which produces an IF signal from the received signal), is sampled at discrete times, and the sampled values are converted into digital sample values. New values are calculated from the digital sample values by rotating the phase of the corresponding IF signals through a predetermined angle in each case. Then each of the corresponding envelope-curve values can be calculated from the corresponding converted value and the new value calculated by the phase rotation.

In other words, each envelope-curve value is calculated from the converted value associated with it and from the new value calculated by rotating the phase of the corresponding value of the sampled region of the received signal.

Embodiments of the invention are described below with reference to the figures.

### SHORT DESCRIPTION OF THE FIGURES

FIG. 1 shows a schematic diagram of the sampling of a received signal.

FIG. 2 shows a schematic diagram of a different sampling of a received signal.

FIG. 3 shows a schematic diagram of a further sampling of a received signal.

FIG. 4A shows the amplitude response of an ideal phase rotator.

FIG. 4B shows the phase response of an ideal phase rotator.

FIG. 5A shows the amplitude response of a real phase rotator for a bandpass signal.

FIG. 5B shows the phase response of a real phase rotator for a bandpass signal.

FIG. 6 shows a block diagram of a method according to an embodiment of the invention.

FIG. 7 shows a level sensor according to an embodiment of the invention that is fitted in a tank.

FIG. 8 illustrates a rotation of the phase of the received signal according to an embodiment of the invention.

FIG. 9 shows a diagram of ZF1 and ZF2, which is phase-rotated with respect to ZF1 through 90°.

FIG. 10A and FIG. 10B each show a diagram of a harmonic wave.

### DETAILED DESCRIPTION OF EMBODIMENTS

The depictions in the figures are schematic and not to scale. In the following description of the figures, the same reference numbers are used for identical or similar elements.

The pulse radar technique generates short coherent microwave pulses, known as bursts, and determines the direct time interval between sending out and receiving the pulses. For typical measurement distances in the range of up to several metres, the time intervals to be measured are extremely short, which is why in pulse radar sensors the received echo signal (also referred to below as the received signal) is expediently expanded in time by a time transformation technique. This technique produces an expanded echo signal which corresponds to the received high frequency transmit-and-receive signal but which runs more slowly in time, for example by a factor of between 10,000 and 100,000. A carrier wave frequency of the microwave pulse of 5.8 GHz, for example, turns into a carrier wave frequency of the time-expanded echo pulse between 58 kHz and 580 kHz, for instance. This signal produced internally by the time transformation is also generally referred to as the intermediate frequency signal or IF signal for short, and typically lies approximately between 10 kHz and 1 MHz, for example between 50 kHz and 200 kHz. This IF signal is a time-expanded representation of the waveform in the time domain of the transmitted and received microwave pulses. The IF signal of the pulse radar technique and echo signal of the ultrasound technique are very similar both in terms of frequency range and the nature of the amplitude characteristic, which is why the further processing and analysis of the signals to determine the relevant echo transit time and hence measurement distance is the same apart from minor differences. So when this description mentions received signals or IF signals, this should be understood to include not only the, if applicable, time-expanded representations of the received microwave signals but also the received ultrasound echo signals, which in principle look identical. The same also applies to other forms of electromagnetic waves such as light, for instance.

An IF signal (and likewise also the non-time-expanded received signal) contains a time sequence of individual pulses, starting from a reference pulse or reference echo derived from the transmit pulse through different pulses or echoes from reflection points within the propagation path of the waves, at which points the wave impedance of the propagation medium changes. Each pulse is composed of a carrier wave of a specific fixed frequency having a pulse-shaped amplitude characteristic defined by the shape of the transmit pulse. The totality of all the echoes over a certain time, between the reference echo occurring and the maximum transit time required for a measurement range of interest, forms the IF signal. A measurement cycle of a level sensor in question is characterised by generating at least part of an IF signal, usually however one or more complete IF signals, and then performing on the basis of the generated IF signal, signal processing, analysis, measured-value generation and measured-value output. Periodic repetition of the measurement cycles guarantees that the measured values are updated in order to track changing levels.

In order to separate, out of a multiplicity of echoes that may arise within an IF signal, that echo produced by the surface of the contained product from the additionally occurring interference echoes, it is necessary to identify the individual echoes from characteristic features. An important feature is the characteristic of the amplitude of an echo having rising amplitude at the beginning, maximum amplitude and falling amplitude at the echo end. This amplitude characteristic is obtained by generating the envelope curve of the IF signal.

In order to avoid the disadvantages of largely analogue signal processing, for example long-term drift, component tolerances and lack of flexibility towards changing sensor parameters, the aim is for largely digital processing of the IF signal. This can be done by sampling the IF signal, after any analogue signal amplification and lowpass or bandpass filtering to avoid aliasing, and converting the time-discrete sample values into a digital value representing the voltage value. This technique is known as A/D conversion. A digitally stored sampling sequence represents the analogue IF signal including all the echoes contained therein. Both the amplitude information and the phase information in the IF signal are retained and are available to the further digital processing of the signal.

The IF signal is typically composed of a plurality of harmonic waves of similar frequency. In the simplest case, however, the IF signal has just one single frequency. When converting the continuous signal into digital values, only abstract instantaneous values, in general the voltage values, of the IF signal are captured.

The associated phase values or phases or phase angles of the A/D-converted values correspond to the time at which the sampling took place. If, in addition, the frequency of the harmonic wave is known, then for every digital sample value a phase value or its phase relative to a reference point can be determined directly.

Hence, for example, it is possible to determine the phase angle or phase between two sample values if the one value is selected as the reference point for the other value.

For a temporal sequence of sample values it can prove advantageous to assign to a sample value the relative phase or phase angle with respect to the previous sample value. The phase value of the first sample value (zero phase angle) can be chosen to suit in this case (equal to 0 is a practical choice).

In this context, vector diagrams and complex numbers can also be used to illustrate this more clearly.

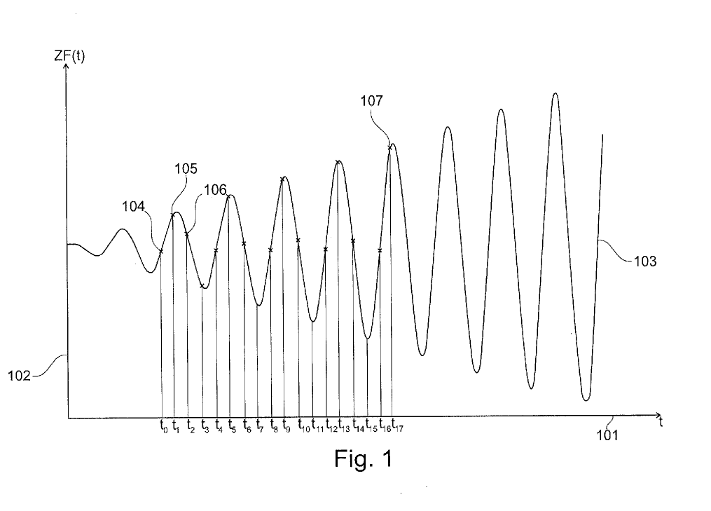

FIG. 1 shows a schematic diagram of the sampling of a received signal, for example of an IF signal. The horizontal axis 101 represents the passage of time, and the vertical axis 102 the instantaneous value of the received signal 103.

Sampling is performed at equidistant intervals at the successive times t0, t1, t2, . . . , t17 and produces the amplitude values 104, 105, 106, . . . , 107 corresponding to these times.

Here sampling complies with the Nyquist-Shannon sampling theorem, as it is known. FIG. 1 shows how values are obtained from a received signal 103, from which values the envelope curve can be calculated according to the formula I in DE 10 2006 006 572 A1, if two sample values have been obtained by analogue/digital conversion (A/D conversion), and the sampling time and the angular frequency of the carrier wave are known.

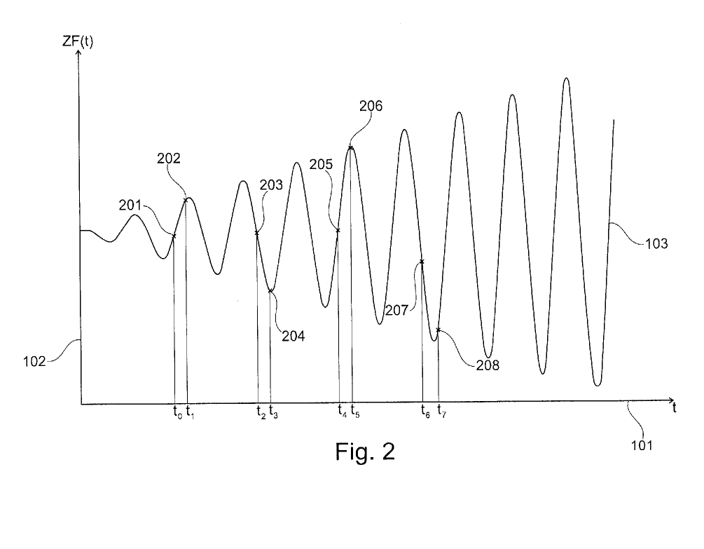

FIG. 2 shows the schematic diagram of a different sampling of a received signal, which sampling does not comply with the Nyquist-Shannon sampling theorem. This situation can also be referred to as subsampling of the received signal. The sampling frequency is selected, however, such that no information content in the signal is lost. This is possible for such subsampling under certain conditions and underlying circumstances.

As can be seen from FIG. 2, sampling is performed at different times, where a shorter time period lies between the sample values at the times t0 201 and t1 202, t2 203 and t3 204, t4 205 and t5 206 or t6 207 and t7 208 than between the values at times t1 and t2, t3 and t4 or t5 and t6.

This case can be referred to as paired sampling, in which the sample values at the times t0, t2, t4 and t6 can be assigned to a first group of sample values, and the values at times t1, t3, t5 and t7 to a second group.

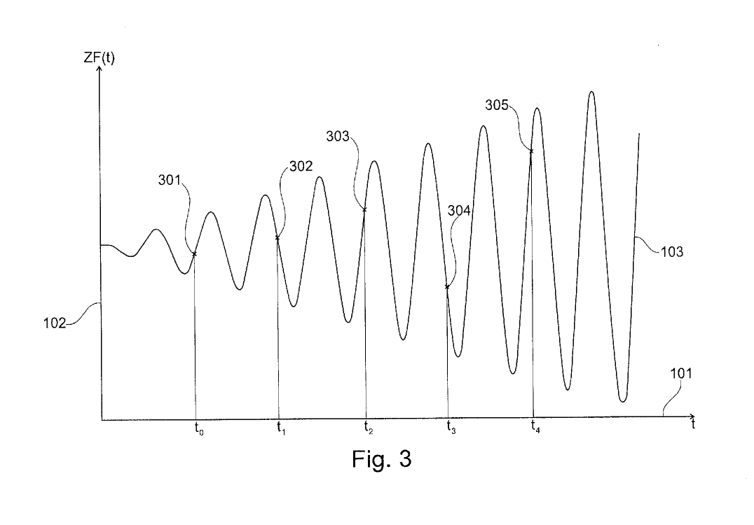

FIG. 3 shows the schematic diagram of a further sampling of a received signal, for example of an IF signal. The signal is sampled at the times t0, t1, t2, t3 and t4 (and at further times if applicable). The instantaneous values of the received signal at these times are represented by the crosses 301 to 305 on the curve of the received signal 103. Again in this case, the received signal is subsampled. This is not necessarily the case, however. The frequency of the subsampling can again be adapted to the signal characteristics so that no information content is lost.

For bandpass signals, under certain conditions, a sampling frequency can be sufficient that is less than the limit specified by the Nyquist-Shannon sampling theorem of twice the frequency of the highest-frequency component. Alias effects of serious consequence can be avoided despite this procedure being designated as subsampling. Reference should be made to DE 10 2006 006 572 A1 on this subject.

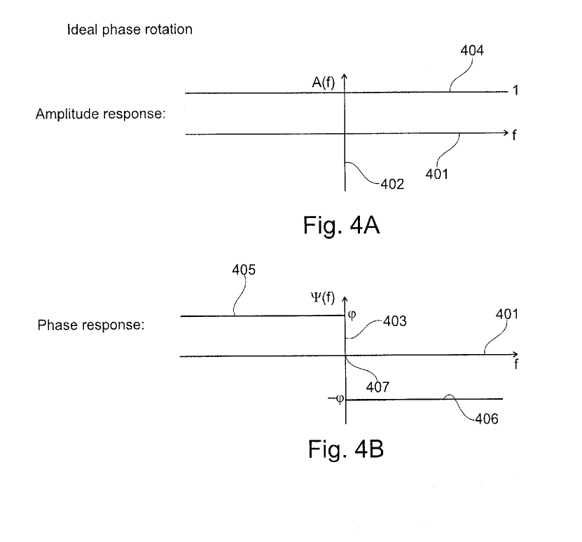

FIG. 4A shows the amplitude response, amplitude characteristic or magnitude of the frequency response A(f) 404 of a “phase rotator” for an idealised case. The horizontal axis 401 represents the frequency, and the vertical axis 402 the amplitude. The amplitude response has a constant value 404 along the entire frequency axis.

FIG. 4B shows the phase response ψ(f) of the phase rotator for this idealised case. The horizontal axis 401 again represents the frequency here, whereas the vertical axis 403 represents the phase rotation. For frequencies less than 0, the signal is rotated through the angle+φ, and for frequency values greater than 0 through the angle−φ(see curve segments 405, 406). For f=0, the angle is 0 (see reference sign 407 at the coordinate origin).

The phase rotator rotates the phase or phase angle with respect to its input data. The input data are the converted values of the received signal. A further value is calculated from at least one first sample value, for which further value, the phase of the underlying IF signal differs from the first sample value by the predetermined angle φ. Like the sampled value, the calculated value is an abstract numerical value. As a rule, the magnitude of both values varies as a function of the angle of rotation cp. The difference in the magnitude in turn results from the underlying IF signal and the angle of rotation. Take as an example an IF signal that has been sampled at the maximum of a period. Let the sampled value be A. The numerical value A of the sampled value varies as a function of the angle of rotation φ. For an angle of 90°, the new second value is calculated as 0, for an angle of 180°, it is calculated as −A, at 270° again as 0, and at 360° as A.

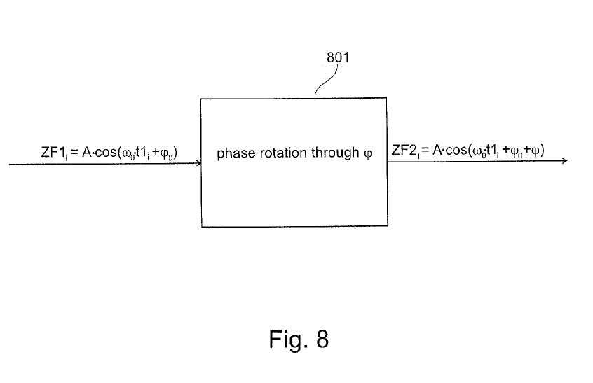

FIG. 8 is intended to illustrate in more detail what is known as a rotation of the phase of a signal or received signal. The continuous received signal presented is described in FIG. 8 by a single harmonic wave. The received signal may also be composed of a plurality of waves, however. Obviously in this case the phase of each component of the signal is then rotated or shifted. The individual notations or variables in the figure are defined as follows:

i: index, i=0, 1, 2, . . .
ZF1ᵢ: digital sample value from the group of digital sample values
ZF2ᵢ: new sample value calculated by rotating the phase
p: predetermined angle through which the phase is rotated (in the context of the invention also
referred to as angle of rotation, phase-rotation angle or phase value)
t1ᵢ: time at which sample ZF1ᵢ was obtained
A: amplitude of the continuous received signal
ω₀: angular frequency of the received signal
φ₀: zero phase angle of the received signal

FIG. 8 shows that the function block 801 generates from the digital sample value ZF1ᵢ a new value ZF2ᵢ, the magnitude of which corresponds to the underlying harmonic wave of the IF signal. In other words, the phase rotation through the angle cp can be understood as shifting by the angle φ the harmonic wave that forms the basis of the sampled received signal. As already described above, the non-time-expanded received signal can also be used instead of an IF signal.

The term phase shifter can also be used alternatively to the term phase rotator.

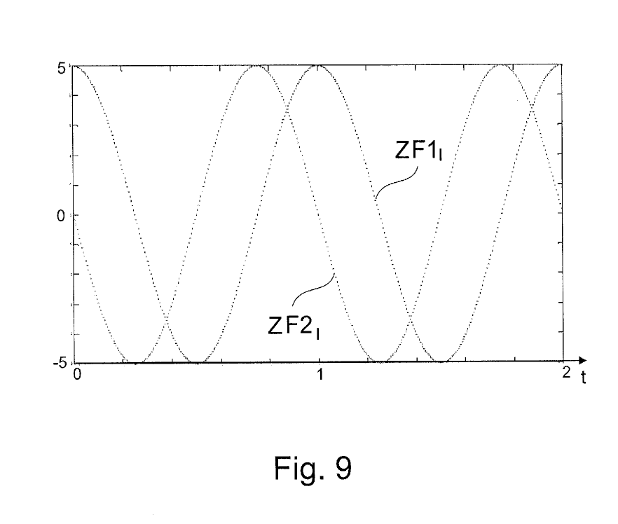

FIG. 8 is intended to illustrate the completely general case of phase rotation of a signal. The amplitude value A is assumed to be constant here. It should be noted that in a radar level meter, this amplitude is affected by echoes. In this case, a term A(t) must be assumed, but this is not used in FIG. 8 for reasons of clarity. FIG. 8 only illustrates the effect of the phase rotation on a wave. The curve shown in FIG. 9 is obtained if the formulae for ZF1ᵢ and ZF2ᵢ from FIG. 8 are plotted on a graph and, for example, the zero phase angle is chosen to be 0, and the angle through which the phase is rotated is chosen to be 90°.

This is a very heavily oversampled signal, however. Such frequent sampling is not necessarily according to the method described here. The signals shown in FIG. 9 are used merely to illustrate the waves.

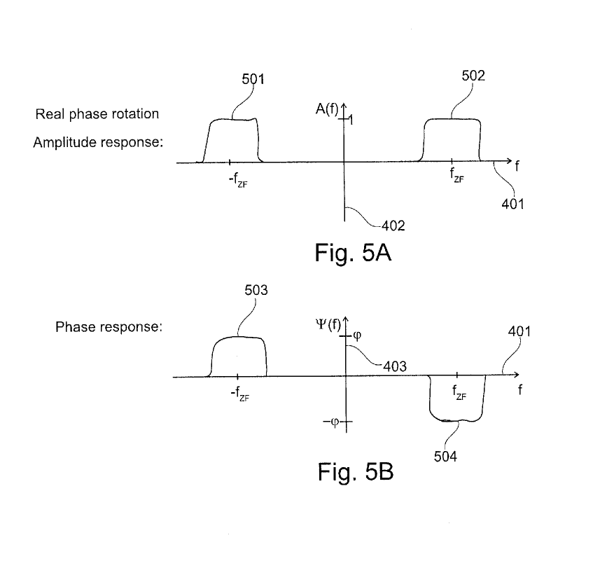

In fact, only the discrete sampling points ZF1ᵢ are sampled. The points ZF2ᵢ are obtained purely arithmetically by rotating the phase. The conversion of ZF1ᵢ into ZF2ᵢ can be performed in a technical implementation by a filter that can have the characteristics given in FIGS. 5A and 5B.

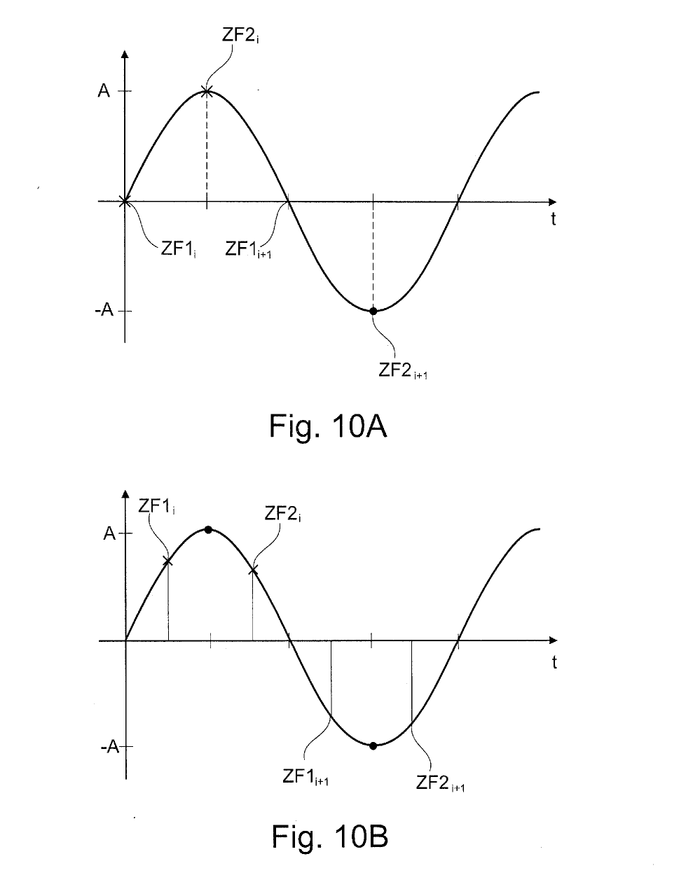

FIGS. 10A and 10B aim to illustrate this again using selected values. Both FIG. 10A and FIG. 10B show the waveform in the time domain of a harmonic wave having an amplitude A, which for simplicity is chosen here to be constant. When sampling the received signal it cannot be guaranteed that only the maxima and minima are sampled. If this were the case then reconstructing the envelopes would be trivial.

FIG. 10A shows the sample values ZF1ᵢ and ZF1ᵢ₊₁ of a harmonic wave that in the simplest case forms the basis of a received signal. The amplitude of both ZF1ᵢ and ZF1ᵢ₊₁ equals 0. It is therefore not possible to reconstruct the magnitude of the amplitude A, or in other words to calculate the envelopes. Taking into account that the signal is a harmonic wave, a phase (also known as a phase angle or angle) of 0° can be assigned to the sample value ZF1ᵢ. Hence a phase of 180° can be assigned to the sample value ZF1ᵢ₊₁. The method according to the invention now rotates the phase of ZF1ᵢ and ZF1ᵢ₊₁ as shown in FIG. 10A through an angle of 90° by way of example. The values ZF2ᵢ and ZF2ᵢ₊₁ are calculated from this. The amplitude of ZF2ᵢ equals exactly A, and that of ZF2ᵢ₊₁−A. Just such a rotation can be implemented technically by means of a filter having appropriate amplitude response, for instance. For an angle of 90°, this is known as a filbert filter or a Hilbert transformer. As a rule, a plurality of sample values of the received signal are needed in this case. The envelope-curve value can now be calculated easily using the formula simplified for φ=90°

HKᵢ=\sqrt{ZF1ᵢ²+ZF2ᵢ²}

It should be mentioned that the sketch is only by way of example, and the calculated values are only correct in the sketches in terms of their magnitude. Of course a filter does not have the property of propagating the value in time. The selected values are known to a person skilled in the art by the terms in-phase and quadrature components or real and imaginary parts of a complex signal. In these cases, however, the described angle must equal 90°, which is not a fundamental requirement for the method according to the invention.

FIG. 10B likewise shows two further sample values ZF1ᵢ and ZF1ᵢ₊₁ of a harmonic wave. Again for this signal, the sample values are not captured at the maxima and minima of the wave. The amplitude A, or in other words the envelope, can therefore only be reconstructed using the calculated values ZF2ᵢ and ZF2₁+1. An angle of 45° can be assigned to the sample values ZF1ᵢ. As shown in FIG. 10B, its converted value equals

A*\sqrt{2}/2

If the received signal from FIG. 10B is then filtered by a filter which, tuned to this wave, has a phase response of 90° and an amplitude response of 1, then the value ZF2ᵢ is obtained, the magnitude of which likewise equals

A*\sqrt{2}/2

In other words, the phase of the sample value ZF1ᵢ has been rotated by the filter to produce the value ZF2ᵢ.

Substituting the values in the simplified formula (for φ=90°)

HKᵢ=\sqrt{ZF1ᵢ²+ZF2ᵢ²}

gives the magnitude of the amplitude A.

The phase rotator can be implemented in a variety of ways and can be achieved technically by an approximation. A suitable approximation, which in the illustrated case is implemented for a bandpass signal, is shown in FIGS. 5A and 5B.

FIG. 5A shows here the amplitude response of a real phase rotator, and FIG. 5B the phase response of a real phase rotator.

As FIGS. 5A and 5B show, amplitude response and phase response are only relevant in the region around the frequencies −f_{ZF} and +f_{ZF}. (See reference signs 501, 502 in FIG. 5A, 503 and 504 in FIG. 5B.) Therefore in the other regions, the amplitude and phase response is indicated as practically 0 by way of example (the amplitude and phase response can also assume other values). The filter should obviously be implemented according to the bandwidth and carrier frequency of the IF signal. For instance it proves sensible if f_{ZF} equals the centre frequency of the IF signal, and the bandwidth of the filter is adjusted to suit the bandwidth of the signal.

The phase rotator can be implemented by a suitable digital filter (FIR or IIR structure), for instance. In this case, filtering is performed in the time domain.

FIR stands for Finite Impulse Response. This structure is a digital filter from digital signal processing having a finite impulse response. IIR stands for Infinite Impulse Response. This structure is a class of special filters from digital signal processing having an infinite impulse response.

The ideal phase rotator can also be approximated by means of the Fourier transform. The received signal sampled in the time domain is Fourier transformed and then digitally filtered in the frequency domain.

$$ψ ( f ) = \{ \begin{matrix}- ϕ , & f > 0 \\ 0 , & f = 0 \\ ϕ , & f < 0\end{matrix}$$

The filter performs a phase-rotation operation on the Fourier-transformed input signal, where the components lying at positive frequencies are rotated through −φ, and those at negative frequencies are rotated through +φ. The phase-shifted signal in the time domain is obtained by the inverse Fourier transform.

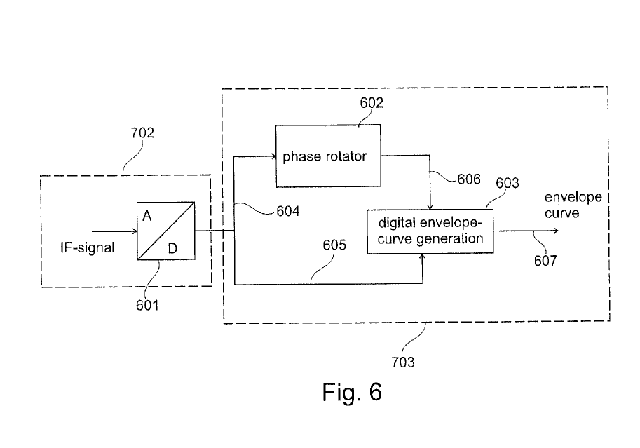

FIG. 6 shows a block diagram of a method according to an embodiment of the invention. The received signal (for example an IF signal) is sampled, and the sampled values are input to an analogue/digital converter 601. This is done in the sampling device 702. In step 604, the converted digital values are input to the phase rotator 602. Here, one of the methods described with reference to FIGS. 5A and 5B is used to perform the phase rotation or rotation of the phase. Both the original, converted sample values (step 605) and the values that have been calculated by the phase rotator 602 (step 606), are transferred to the function block “digital envelope generation” 603. Phase rotator and function block “digital envelope generation” are located in the digital signal processing device 703.

The individual envelope-curve values from which the envelope curve is obtained (see reference sign 607) can be calculated using the formula

$${HK}_{i} = \sqrt{ZF {1}_{i}^{2} + \frac{{( ZF {2}_{i} - ZF {1}_{i} \cdot cos ( {ϕ}_{i} ) )}^{2}}{{sin}^{2} ( {ϕ}_{i} )}}$$

where:
i: index, i=0, 1, 2, . . .
HKᵢ: envelope-curve value
ZF1ᵢ: digital sample value from the group of digital sample values
ZF2ᵢ: new sample value calculated by rotating the phase
φi: predetermined phase-rotation angle (phase value)

φᵢ equals the phase-rotation angle (phase value) between the converted IF signal (first group of sample values (ZF1)) and the calculated phase-shifted IF signal (second group of sample values (ZF2)). A multiplicity of digital sample values from the first group ZF1 (e.g. all) can be used in the sample-value calculation.

φᵢ must be predetermined in a technical implementation. Knowing the phase values φᵢ, the converted sample values ZF1ᵢ and the calculated values ZF2ᵢ, the formula above can be used to calculate the envelope curve or more precisely its reference points.

The formula above is generally true and is used to calculate the envelope-curve values for any angle φ. It can be advantageous if the angle φ is chosen to equal 90°. This then results in the simplified formula

HKᵢ=\sqrt{ZF1ᵢ²+ZF2ᵢ²}

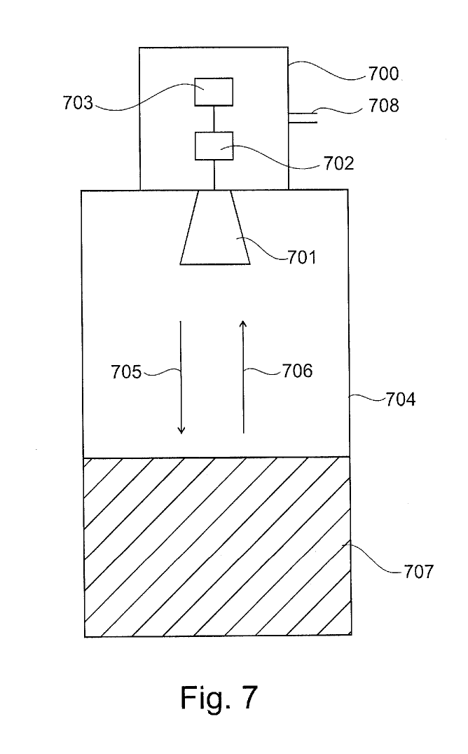

FIG. 7 shows a level sensor 700, which is mounted on a container 704 and is used to determine the level of the medium 707 contained in the container. The sensor 700 is designed as a pulse transit-time level sensor and comprises a transmit/receive antenna 701, which sends out a transmit signal 705 to the surface of the contained product. The signal 706 reflected at the surface is received by the transmit/receive unit 701, and the received signal is then transferred to the sampling device 702. Before sampling, the signal may be time-expanded if applicable, resulting in what is known as an IF signal. The (possibly time-expanded) received signal is sampled, and the sampled values are converted into digital sample values. The digitised sample values are then transferred to the digital signal processing device 703 in which the envelope-curve values are calculated (as described above).

The sensor 700 is connected to the outside world via the two-wire loop 708, for example. The supply of power and the transfer of data are both performed via the two-wire loop 708.

The method according to the invention enables calculation of the envelope curve using fewer sample values than in comparable methods. The sampling rate of the A/D converter can be reduced. The power consumed by the A/D conversion drops and it is possible to use A/D converters of a lower technical specification.

By calculating the values in the one group from the values in the other group, the iterative calculation necessary in the known methods for more precise generation of the envelope curve is no longer necessary because the amplitude of the envelope curve does not change between the sampled values in the one group and the calculated values in the other group.

The sampling can be (but does not have to be) performed at equidistant times. This results in a simpler implementation of the controller for the A/D converter.

Unlike known pulse transit-time level sensors, only one A/D converter is required, so that it is possible to save on one of the two A/D converters used.

In addition, it should be mentioned that the terms “comprising” and “having” do not exclude any other elements or steps, and “a” or “an” does not rule out more than one. It should also be pointed out that features or steps that have been described with reference to one of the above embodiments can also be used in combination with other features or steps of other embodiments described above. Reference signs in the claims shall not be deemed to have a limiting effect.

1-14. (canceled)

15. A method for calculating an envelope-curve value in a level measurement by a level sensor, comprising steps of:
sampling a received signal of the level sensor at discrete times, resulting in sample values;
converting the sample values of the sampled received signal into digital sample values;
calculating a new value for a first digital sample value of the digital sample values by rotating the phase of the sample value through a predetermined angle, for example using a digital filter in the time domain or in the frequency domain; and
calculating an envelope-curve value from the first digital sample value and from the new value calculated by the phase rotation.

16. The method according to claim 15, wherein the received signal is converted into a time-expanded intermediate frequency signal before sampling.

17. The method according to claim 15, wherein the envelope-curve value is calculated according to
$${HK}_{i} = \sqrt{ZF {1}_{i}^{2} + \frac{{( ZF {2}_{i} - ZF {1}_{i} \cdot cos ( {ϕ}_{i} ) )}^{2}}{{sin}^{2} ( {ϕ}_{i} )}}$$
where:
i: index, i=0, 1, 2, . . .
HKᵢ: envelope-curve value
ZF1ᵢ: digital sample value from the group of digital sample values
ZF2ᵢ: new sample value calculated by rotating the phase
φi: predetermined angle.

18. The method according to claim 15, wherein the conversion of the sample values into digital sample values is performed by subsampling.

19. The method according to claim 15, wherein the predetermined angle has a value not equal to 90°.

20. The method according to claim 15, wherein the digital filter in the time domain has an FIR filter structure or an IIR filter structure.

21. The method according to claim 15, wherein the digital filter in the frequency domain performs a Fourier transform.

22. The method according to claim 15, wherein the phase rotation is performed by a Hilbert filter and hence the predetermined angle has a value equal to 90°.

23. The method according to claim 15, wherein coherent ensemble averaging is performed before calculating the envelope curve.

24. The method according to claim 15, wherein a multiplicity of envelope-curve values are calculated, from which the envelope curve is determined.

25. A level sensor for calculating an envelope-curve value of an envelope curve and for determining a level, comprising:
a sampling device sampling at least one region of a received signal at discrete times, resulting in sampling values, and converting the sampled values of the sampled received signal into digital sample values; and
a digital signal processing device:
calculating a new value for a first digital sample value of the digital sample values by rotating the phase of the sample value through a predetermined angle, for example using a digital filter in the time domain or in the frequency domain; and
calculating an envelope-curve value from the first digital sample value and from the new value calculated by the phase rotation.

26. A sampling and signal-processing apparatus, comprising:
a sampling device; and
a processor calculating an envelope-curve value of an analogue signal, designed to perform the following steps:
sampling at least one region of the analogue signal at discrete times, resulting in sampling values;
converting the sampled values of the sampled signal into digital sample values;
calculating a new value for a first digital sample value of the digital sample values by rotating the phase of the sample value through a predetermined angle, for example using a digital filter in the time domain or in the frequency domain; and calculating an envelope-curve value from the first digital sample value and from the new value calculated by the phase rotation.

27. A program element, which, when implemented on a sampling and signal-processing apparatus, instructs the apparatus to perform the following steps:
sampling at least one region of the analogue signal at discrete times, resulting in sampling values;
converting the sampled values of the sampled signal into digital sample values;
calculating a new value for a first digital sample value of the digital sample values by rotating the phase of the sample value through a predetermined angle, for example using a digital filter in the time domain or in the frequency domain;
calculating an envelope-curve value from the first digital sample value and from the new value calculated by the phase rotation.

28. A computer readable medium, on which a program element according to claim 27 is stored.
